(19) United States
(12) Patent Application Publication
(10) Pub. No.: US 2026/0180078 A1
(43) Pub. Date: Jun. 25, 2026

(54) CARBON STRUCTURE, AIR BATTERY, AND PROCESS OF PRODUCING THE CARBON STRUCTURE

(71) Applicant: NATIONAL INSTITUTE FOR MATERIALS SCIENCE, lbaraki (JP)

(72) Inventors: Takashi KAMEDA, Ibaraki (JP); Shoichi MATSUDA, Ibaraki (JP); Shoji YAMAGUCHI, Ibaraki (JP); Takaya SAITO, Tokyo (JP); Shuntaro MIYAKAWA, Tokyo (JP)

(73) Assignee: NATIONAL INSTITUTE FOR MATERIALS SCIENCE, Ibaraki (JP)

(21) Appl. No.: 19/126,340

(22) PCT Filed: Dec. 4, 2023
(86) PCT No.: PCT/JP2023/043302

§ 371 Date: May 1, 2025

(30) Foreign Application Priority Data
Dec. 26, 2022 (JP) 2022-207774

(51) Int. Cl. H01M 12/06; H01M 4/02

(52) U.S. Cl. CPC H01M 12/06; H01M 2004/027

(57) ABSTRACT

The invention provides a carbon structure for the positive electrode of an air battery, which comprises a carbon nanotube as a carbon material, wherein the carbon nanotube has an average diameter of 1 nm to 10 nm inclusive, an average length of 1 μm to 100 μm inclusive, and an aspect ratio of 1,000 to 10,000 inclusive.

### TECHNICAL FIELD

The present invention relates to a carbon structure used for a positive electrode of an air battery, an air battery comprising the same, and a process of producing the carbon structure.

### BACKGROUND ART

Attention has now been focused on batteries as drive for supporting smart societies, which are greatly on demand. There is a diversity of batteries, among which an air battery is noteworthy because of compactness, light weight, and a structure suitable for increased capacities.

The air battery uses oxygen in the atmospheric air as a positive electrode active material, and a metal as a negative electrode active material, and is called a metal air battery that is a type of fuel batteries, as by represented by a lithium air battery using as a anode active material a metal or compound capable of occluding or releasing lithium ions. Reactions at the respective electrodes of the lithium air battery are expressed as follows.

Negative Electrode: 2Li⇔2Li⁺+2e⁻

Positive Electrode: 2Li⁺+2e⁻+O₂⇔Li₂O₂

In the air battery, the positive electrode active material is oxygen, and the positive electrode works occluding or releasing oxygen in the atmospheric air in association with charge and discharge. For this reason, the carbon structure used for the positive electrode should take in much oxygen from the air; that is, the positive electrode carbon structure should be highly permeable to air or oxygen.

For enhancement of the output and capacity of a lithium air battery cell, the carbon structure used as a positive electrode is also required high ion transport efficiency and a wide reaction site, which is characteristics demanded for batteries in general.

Further to reduce the size and weight of the air battery with a view to cost reductions, it is desired for the carbon structure for positive electrodes to stand alone or have a self-supporting capability.

Under such circumstances, Patent Publication 1 proposes a lithium air battery making use of a positive electrode layer wherein a first pore volume taken by pores having a diameter of 1 nm to 200 nm inclusive is larger than a second pore volume taken by a pore having a diameter of 200 nm to 1,000 nm inclusive.

Patent Publication 1 also discloses how to form the positive electrode layer by a process comprising coating of a coating material including a composition containing an electrically conductive porous material and a binder, etc. dispersed in a solvent by a doctor blade on a positive electrode collector or a process of molding the composition by crimping press. In addition, Patent Publication 1 refers to stainless steel, nickel, aluminum or carbon as the collector having such shapes as foil, plate or mesh, preferably a mesh shape.

Patent Publication 2 proposes using a self-supporting carbon structure having a specific pore structure and physical properties as a positive electrode of an air battery. The carbon structure described in Patent Publication 2 does not only have a high pore volume but a self-supporting capability.

### PRIOR ART PUBLICATIONS

### Patent Publications

Patent Publication 1: JP(A) 2018-133168
Patent Publication 2: WO(A1) 2020/235638

### SUMMARY OF THE INVENTION

### Subject Matter of the Invention

The positive electrode layer disclosed in Patent Publication 1 comprises a collector. The collector in the positive electrode layer referred to therein is capable of holding a composition including an electrically conductive porous material, a binder or the like. However, the collector would not work as any site where during discharge lithium ions, oxygen and electrons react together to yield lithium peroxide. With battery weight reductions in mind, therefore, a positive electrode structure without recourse to any collector is desired.

The carbon structure of Patent Publication 2 has a self-supporting capability, and when used as the positive electrode of an air battery, it makes sure of a large discharge capacity due to its enhanced pore volume. To maintain the shape of the carbon structure, however, it is necessary to contain carbon fibers therein as a reinforcing material.

Although the reinforcing carbon fibers is somehow helpful to keep the carbon structure in shape, they do not contribute at all to any site where lithium ions, oxygen and electrons react together to form lithium peroxide. In other words, the inclusion of carbon fibers will give rise to decreases in the discharge capacity of the air battery in association with their content.

The carbon structure of Patent Publication 2 is manufactured by carbonization in an oxidizing gas atmosphere. More specifically, it is fabricated by carbonization in an oxidizing gas atmosphere having an oxygen concentration of 0.03% or more but less than 5% in a temperature range of 350° C. to 3,000° C. Considering that carbonization in an oxidizing gas atmosphere requires fine control of oxygen concentration and temperature, the carbon structure of Patent Publication 2 would not be easy to manufacture. Further, carbonization in the oxidizing gas atmosphere needs installation resistant to oxidation, resulting in increased production costs.

It is noted that Patent Publication 2 shows in the examples that a carbon structure carbonized in the oxidizing gas atmosphere has a high discharge capacity, whereas a carbon structure carbonized in an inert atmosphere alone without recourse to any carbonization in the oxidizing gas atmosphere remains low in capacity.

Having been achieved with the foregoing in mind, the present invention has for its purpose to provide a carbon structure for a positive electrode of an air battery, which can maintain its shape and have self-supporting capabilities even without containing a collector and supporting materials such as carbon fiber and enable the air battery to have an increased discharge capacity without recourse to any carbonization step in an oxidizing gas atmosphere.

### Means for Providing a Solution to the Problems

The present inventor has made study after study for the purpose of providing a solution to the aforesaid problems. Consequently, the present invention has been accomplished by finding that a carbon nanotube having a specific physical feature(s) is used as a starting carbon material so that a carbon structure capable of maintaining a self-supporting shape and embodying an air battery having a large capacity without recourse to any carbonization step in an oxidizing gas atmosphere.

More specifically, the invention of the present disclosure has the following embodiments.

[1]

A carbon structure for a positive electrode of an air battery, which comprises a carbon nanotube as a carbon material wherein said carbon nanotube has an average diameter of 1 nm to 10 nm inclusive, an average length of 1 μm to 100 μm inclusive, and an aspect ratio of 1,000 to 10,000 inclusive.

[2]

The carbon structure according to Embodiment [1], which consists solely of said carbon material, and carbon derived from a binding polymeric material of binding carbon materials together.

[3]

The carbon structure according to Embodiment [1] or [2], which has
(a) a pore volume of 1.0 cm³/g to 3.0 cm³/g inclusive taken up by a pore having a diameter of 1 nm to 1,000 nm inclusive as measured by a nitrogen adsorption method,
(b) a pore volume of 1.0 cm³/g to 2.3 cm³ inclusive taken up by a pore having a diameter of 1 nm to 200 nm inclusive as measured by a nitrogen adsorption method,
(c) a pore volume of 1.0 cm³/g to 3.3 cm³/g inclusive taken up by a pore having a diameter of 200 nm to 10,000 nm inclusive as measured by a mercury intrusion method,
(d) a t-plot outer specific surface area of 100 m²/g to 300 m²/g inclusive as measured by a nitrogen adsorption method,
(e) an apparent density of 0.15 g/cm³ to 0.30 g/cm³ inclusive, and
(f) a porosity of 70% to 90% inclusive.
   [4]

The carbon structure according to any one of Embodiments [1] to [3], which has a self-supporting capability.

[5]

A positive electrode for an air battery, which comprises the carbon structure according to any one of Embodiments [1] to [4].

[6]

An air battery, comprising:
the positive electrode for an air battery according to Embodiment [5],
a negative electrode, and
an electrolyte located between said positive electrode for an air battery and said negative electrode.
   [7]

The air battery according to Embodiment [6], wherein said negative electrode includes a lithium metal.

[8]

A process of manufacturing the carbon structure according to any one of Embodiments [2] to [4] comprising:
preparing a mixed slurry containing said carbon material and said binding polymeric material,
molding said mixed slurry to obtain a mixed slurry molded assembly,
immersing said mixed slurry molded assembly in a solvent having a lower solubility for said binder polymeric material to obtain a porous structure,
drying said porous structure to obtain a carbon structure precursor, and
carbonizing said carbon structure precursor in an inert atmosphere to obtain a carbon structure.
   [9]

The process of manufacturing the carbon structure according to Embodiment [8], wherein said carbonization is carried out in a temperature range of 500° C. to 3,000° C. inclusive.

[10]

The process of manufacturing the carbon structure according to Embodiment [8] or [9], wherein subsequent to the provision of said carbon structure precursor by drying of said porous structure and prior to said carbonization, said carbon structure precursor is further made infusible to obtain an infusible carbon structure, wherein:
said infusible carbon structure is subjected to said carbonization.

### Advantages of the Invention

The carbon structure according to the invention could remain in shape and have a self-supporting capability only by use of material where a carbon material and a binding polymetric material are carbonized. Since the carbon structure of the invention does not require a collector or reinforcing materials such as carbon fiber for shape retention, it can reduce the area that doesn't contribute to charge/discharge reaction, in other words, the area that does not contribute to the discharge capacity. This makes it possible to increase the discharge capacity per carbon structure and to provide an air battery having compactness and lightweight with an increased discharge capacity.

Although the carbon structure disclosed herein is manufactured without recourse to carbonization in an oxidizing gas atmosphere, it could be used for assembling of an air battery having a large discharge capacity. Thus, the carbon structure of this disclosure is easier in production and lower in cost than a conventional one produced by carbonization in an oxidizing gas atmosphere, when an air battery having a large discharge capacity is realized.

### BRIEF EXPLANATION OF THE DRAWINGS

FIG. 1 is a flowchart showing the steps of producing the carbon structure disclosed herein.

FIG. 2 is a schematic sectional view of an air battery according to one embodiment of the invention.

FIG. 3 is a schematic sectional view of an air battery according to another embodiment of the invention.

FIG. 4 is a schematic sectional view of an air battery according to yet another embodiment of the invention.

FIG. 5 is a schematic sectional view of a coin cell prepared in an example, and a comparative example.

### MODES FOR IMPLEMENTING THE INVENTION

In what follows, some embodiments of the invention will be explained with reference to the drawings. Like elements, indicated by like numerals, will not be explained anymore. It is here noted that the present invention is not limited to such embodiments.

### <<Carbon Structure>>

The carbon structure of the invention is designed for use with a positive electrode of an air battery, and includes carbon nanotubes as the carbon material. This carbon structure has a self-supporting capability, and is capable of forming a positive electrode structure on its own.

In the present disclosure, the wording “having a self-supporting capability” is understood to refer to a film structure capable of keeping shape as a self-supporting film (also called herein a “self-supporting film”). The carbon structure disclosed herein comprises a skeleton composed mainly of carbon, with a thickness in a range of preferably 20 μm to 800 μm, and more preferably 30 μm to 500 μm.

More specifically, the carbon structure (i.e., self-supporting film) disclosed herein may provide a positive electrode structure of an air battery on its own even in the absence of any supporting substance formed of a collector such as metal mesh consisting of a single metal such as copper (Cu), tungsten (W), aluminum (Al), nickel (Ni), titanium (Ti), gold (Au), silver (Ag), platinum (Pt), palladium (Pd) and stainless (SUS) as well as a substance composed of a metal foil such as an aluminum foil, a nickel foil or a SUS foil.

### <Carbon Material>

The carbon structure disclosed herein contains as a starting carbon material a carbon nanotube having an average diameter of 1 nm to 10 nm inclusive, an average length of 1 μm to 100 μm inclusive, and a length to diameter ratio or aspect ratio of 1,000 to 10,000 inclusive.

It is here noted that if the carbon structure of the invention contains the aforesaid carbon nanotubes as the starting carbon material, it may then contain other carbon materials without detrimental to the advantages of the invention.

If the average diameter, average length and aspect ratio of the carbon nanotubes forming the carbon material are within the aforesaid ranges, the carbon structure production process, as described later, makes it possible to obtain a carbon structure that can maintain shape and have a self-supporting capability without recourse to addition of a reinforcing material such as carbon fibers and provide an air battery having a large discharge capacity.

By using the carbon nanotubes having various features in the aforesaid ranges as the starting carbon material and implementing the carbon structure manufacturing process as will be described later, the carbon structure of the invention is maintained in a given shape and allowed to have a self-supporting capability only by the carbon nanotubes and carbon derived from the polymeric binder for binding them together.

### (Average Diameter)

The carbon nanotubes providing the raw material of the inventive carbon structure have an average diameter of 1 nm to 10 nm inclusive. With carbon nanotubes having an average diameter of more than 10 nm, the carbon nanotubes in the carbon structure do not only decrease in number but sites where lithium peroxide is formed by discharge reactions also reduce in number, giving rise to a decrease in the discharge capacity of the resultant air battery. Carbon nanotubes of less than 1 nm in diameter are difficult to produce and less available.

The carbon nanotubes may have an average diameter of 1.2 nm or more, 1.4 nm or more or 1.5 nm or more or, alternatively, 7 nm or less, 5 nm or less or 3 nm or less.

### (Average Length)

The carbon nanotubes providing the raw material of the inventive carbon structure have an average length of 1 μm to 100 μm inclusive. With carbon nanotubes having an average length shorter than 1 μm, they remain powdery; even when, according to the carbon structure manufacturing process as described later, the carbon nanotubes are mixed with a binding polymeric material and a solvent to prepare a mixed slurry which is then coated and dried, the coated film would crumble due to weak binding forces of binding carbon nanotubes together. In this case, if carbon fibers or the like are added as a reinforcing material, it may then be possible to obtain some carbon structure capable of maintaining shape with a self-supporting capability. However, the carbon fibers or other reinforcing material do not contribute at all to discharge capacity and gives rise to a decrease in the resulting air battery capacity with the result that the battery mass increases, and compactness is hardly achievable.

On the other hand, when the carbon nanotubes have an average length exceeding 100 μm, in the step of mixing them with a binding polymeric material and a solvent to prepare a mixed slurry, the carbon nanotubes are poorly dispersed with the result that even when it is coated for molding the mixed slurry, it is crumped rendering it difficult to obtain any molded product. In this case too, if carbon fibers or the like are added as a reinforcing material, it may then be possible to obtain some carbon structure capable of maintaining shape with a self-supporting capability. As mentioned above, however, the carbon fibers or other reinforcing material do not contribute at all to discharge capacity and, correspondingly, gives rise to a decrease in the resulting air battery capacity with the result that the battery mass increases, and compactness is hardly achievable.

The carbon nanotubes may have an average length of 2 μm or more, 3 μm or more or 4 μm or more or, alternatively, 70 μm or less, 40 μm or less or 20 μm or less.

### (Aspect Ratio)

The carbon nanotubes providing the raw material of the inventive carbon structure have an aspect ratio of 1,000 to 10,000 inclusive. When the aspect ratio of carbon nanotubes is less than 1,000, they remain powdery due to a relatively short length. Hence, in the step of mixing them with a binding polymeric material and a solvent to prepare a mixed slurry which is then coated and dried for molding the mixed slurry, the coated film comes apart as the binding force between carbon nanotubes gets weak.

On the other hand, when the carbon nanotubes have an aspect ratio exceeding 10,000, in the step of mixing them with a binding polymeric material and a solvent to prepare a mixed slurry, they are poorly dispersed due to their relatively long length with the result that even upon of coating the mixed slurry for molding, they are crumped rendering it difficult to obtain any molded assembly.

The carbon nanotubes may have an aspect ratio of 2,000 or more, 2,500 or more or 3,000 or more or, alternatively, 8,000 or less, 7,000 or less or 6,000 or less.

### <Physical Properties of the Carbon Structure>

The carbon structure of the invention has preferably the following physical properties:
(a) a pore volume of 1.0 cm³/g to 3.0 cm³/g inclusive taken up by a pore having a diameter of 1 nm to 1,000 nm inclusive as measured by a nitrogen adsorption method,
(b) a pore volume of 1.0 cm³/g to 2.3 cm³ inclusive taken up by a pore having a diameter of 1 nm to 200 nm inclusive as measured by a nitrogen adsorption method,
(c) a pore volume of 1.0 cm³/g to 3.3 cm³/g inclusive taken up by a pore having a diameter of 200 nm to 10,000 nm inclusive as measured by a mercury intrusion method,
(d) a t-plot outer specific surface area of 100 m²/g to 300 m²/g inclusive as measured by a nitrogen adsorption method,
(e) an apparent density of 0.15 g/cm³ to 0.30 g/cm³ inclusive, and
(f) a porosity of 70% to 90% inclusive.

### (a) Pore Volume Taken Up by a Pore Having a Diameter of 1 nm to 1,000 nm Inclusive

In the carbon structure of the invention, it is preferred that (a) the pore volume taken up by a pore having a diameter of 1 nm to 1,000 nm inclusive is 1.0 cm³ to 3.0 cm³ inclusive as measured by a nitrogen adsorption method. It is here noted that (a) the pore volume taken up by a pore having a diameter of 1 nm to 1,000 nm inclusive as measured by a nitrogen adsorption method is found by rounding the second decimal place.

Due to the carbon structure has (a) the pore volume taken up by a pore having a diameter of 1 nm to 1,000 nm inclusive as measured by a nitrogen adsorption method within the aforesaid range, lithium peroxide generated by discharge can be more stored to provide a battery having a high discharge capacity feature when the carbon structure is used for a positive electrode of an air battery. With the pores in this pore diameter range having a large volume, an air or oxygen is easily transmitted through the carbon structure so that the air or oxygen entering the positive electrode from outside the battery can be extended at high speeds over the entire breadth of the carbon nanotube that forms the carbon skeleton. Furthermore, the large pore volume of this pore diameter range makes movement of lithium (Li) ions smoother which, combined with fast air or oxygen transmission and diffusion, renders it possible to provide an air battery more enhanced in terms of fast discharge capability, i.e., high load characteristics.

(a) The pore volume taken up by pores having a diameter of 1 nm to 1,000 nm inclusive as measured by a nitrogen adsorption method of the carbon structure may be more preferably 1.2 cm³/g or more, 1.4 cm³/g or more, 1.6 cm³/g or more or 2.0 cm³/g or more, in which a battery more improved in terms of charge/discharge characteristics can be provided. On the other hand, (a) the pore volume taken up by pores having a diameter of 1 nm to 1,000 nm inclusive as measured by a nitrogen adsorption method may be more preferably 2.9 cm³/g or less, 2.8 cm³/g or less, 2.7 cm³/g or 2.0 cm³/g or less, in which the carbon structure can maintain a self-supporting capability with good enough strength.

### (b) Pore Volume Taken Up by Pores Having a Diameter of 1 nm to 200 nm Inclusive

In the carbon structure of the invention, it is preferable that (b) the pore volume taken up by pores having a diameter of 1 nm to 200 nm inclusive as measured by a nitrogen adsorption method is 1.0 cm³/g to 2.3 cm³/g inclusive. It is here noted that (b) the pore volume taken up by a pore having a diameter of 1 nm to 200 nm inclusive as measured by a nitrogen adsorption method is found by rounding the second decimal place.

The fact that (b) the pore volume of the carbon structure taken up by pores having a diameter of 1 nm to 200 nm inclusive as measured by a nitrogen adsorption method is in the aforesaid range means that the pore volume is large irrespective of the pore diameter being in a relatively small range, suggesting that there are much more pores. In other words, when such a carbon structure is assembled as an air battery, it provides more sites where lithium ions and oxygen react in a discharge process, thereby enabling to provide a battery having a high discharge capacity.

(b) The pore volume taken up by pores having a diameter of 1 nm to 200 nm inclusive as measured by a nitrogen adsorption method of the carbon structure may be more preferably 1.1 cm³/g or more, 1.5 cm³/g or more, 1.8 cm³/g or more or particularly 2.0 cm³/g or more, in which an air battery with the carbon structure used as a positive electrode makes charge/discharge faster. On the other hand, (b) the pore volume taken up by pores having a diameter of 1 nm to 200 nm inclusive as measured by a nitrogen adsorption method may be more preferably 2.2 cm³/g or less, 1.8 cm³/g or less, 1.5 cm³/g or less, or 1.2 cm³/g or less, in which the carbon structure can maintain a self-supporting capability with good enough strength.

### (c) Pore Volume Taken Up by Pores Having a Diameter of 200 nm to 10,000 nm Inclusive

In the carbon structure of the invention, it is preferable that (c) the pore volume taken up by pores having a diameter of 200 nm to 10,000 nm inclusive as measured by a mercury intrusion method is 1.0 cm³/g to 3.3 cm³/g inclusive. It is here noted that (c) the pore volume taken up by a pore having a diameter of 200 nm to 10,000 nm inclusive as measured by a mercury intrusion method is determined by rounding the first decimal place.

(c) The pores having a diameter of 200 nm to 10,000 nm inclusive as measured by a mercury intrusion method of the carbon structure work primarily to allow oxygen to enter or go within the carbon structure acting as the positive electrode from outside. For this reason, the fact that the pores in the aforesaid diameter range have a large volume suggests that when lithium ions and oxygen react to generate lithium peroxide, a sufficient amount of oxygen can be supplied at a faster speed. This assures that the air battery with the inventive carbon structure used as a positive electrode has an increased discharge capacity at a high current density; it is improved in terms of high load characteristics. In a charge process, lithium peroxide gives electrons to the electrode where Li ions and oxygen are generated. So if the volume of the pores having a diameter of 200 nm to 10,000 nm inclusive comes within the aforesaid range, oxygen generated from the carbon structure gets out satisfactorily, rendering fast charge feasible.

(c) The pore volume taken up by pores having a diameter of 200 nm to 10,000 nm inclusive as measured by a mercury intrusion method of the carbon structure may more preferably be 1.1 cm³/g or more, 1.5 cm³/g or more, 2.0 cm³/g or more, or 2.5 cm³/g or more wherein oxygen comes in and out of the positive electrode at faster speeds. On the other hand, (c) the pore volume taken up by pores having a diameter of 200 nm to 10,000 nm inclusive as measured by a mercury intrusion method may preferably be too not large, say, 3.0 cm³/g or less, 2.0 cm³/g or more, or 1.5 cm³/g or less wherein the strength of the carbon structure can be maintained.

(d) t-Plot Outer Specific Surface Area Measured by a Nitrogen Adsorption Method

The inventive carbon structure has preferably (d) a t-plot outer specific surface of 100 m²/g to 300 m²/g inclusive as measured by a nitrogen adsorption method. It is here noted that (d) the t-plot outer specific surface area as measured by a nitrogen adsorption method is found by rounding the first decimal place.

The t-plot outer specific surface area is found from a graph plotted with a nitrogen adsorption layer thickness as abscissa and an adsorption amount as ordinate, based on an adsorption isotherm obtained by nitrogen adsorption measurement. A value obtained by subtracting this t-plot outer specific surface area from a BET (Brunauer-Emmett-Teller) specific surface area found by the same nitrogen adsorption measurement is defined as a t-plot micropore specific surface area. Pores expressed by t-plot micropores do hardly contribute to discharge reactions because they are too small to receive lithium ions and oxygen via immersion. In other words, the t-plot outer specific surface area stands for a specific surface area of pores effective for discharge reactions as well as charge reactions.

In the carbon structure, (d) the t-plot outer specific surface area as measured by a nitrogen adsorption method being in the range of 100 m²/g to 300 m²/g inclusive is derived from the t-plot outer specific surface area of the starting carbon nanotubes. Thus, the value of this carbon structure is smaller than that of the starting carbon nanotubes because carbon derived from the polymeric binder is linked to the carbon nanotubes.

When the carbon structure having (d) a t-plot outer specific surface area of 100 m²/g or more as measured by a nitrogen adsorption method is used as the positive electrode of an air battery, lithium ions and oxygen react to generate lithium peroxide to make sure of the reaction sites needed for oxygen to receive electrons fed out of the positive electrode, resulting in a large discharge capacity. When (d) the t-plot outer specific surface area as measured by a nitrogen adsorption method is 300 m²/g or less, on the other hand, there is another advantage obtained in association with charge/discharge features because any contribution to battery side reactions on the positive electrode surface is held back.

In consideration of taking hold of much more reaction sites, (d) the t-plot outer specific surface area as measured by a nitrogen adsorption method of the carbon structure may more preferably be 120 m²/g or more, 140 m²/g or more, 160 m²/g or more, 180 m²/g or more, or 200 m²/g or more. In consideration of more reducing battery side reactions on the electrode surface, on the other hand, (d) the t-plot outer specific surface area as measured by a nitrogen adsorption method may be 280 m²/g or less, 250 m²/g or less, 200 m²/g or less, or 180 m²/g or less.

### (e) Apparent Density

The inventive carbon structure has preferably (e) an apparent density of 0.15 g/cm³ to 0.30 g/cm³ inclusive wherein the carbon structure could have enough pores needed for transmission and diffusion of an air or oxygen as well as enough strength. Below this range there may possibly be a drop of the carbon structure's strength, and above this range there may possibly be a decrease in the pores necessary for transmission and diffusion of an air or oxygen.

In order to make the carbon structure's strength much higher, the carbon structure may more preferably have (e) an apparent density of 0.16 g/cm³ or more, 0.18 g/cm³ or more, 0.20 g/cm³ or more or 0.22 g/cm³ or more. In order to provide a carbon structure having enough pores, on the other hand, the carbon structure may more preferably have (e) an apparent density of 0.29 g/cm³ or less, 0.28 g/cm³ or less, 0.25 g/cm³ or less, or 0.22 g/cm³ or less.

### (f) Porosity

The inventive carbon structure has (f) a porosity of 70% to 90% inclusive, in which range the carbon structure could have enough pores needed for transmission and diffusion of an air or oxygen as well as enough strength. Above this porosity range there may possibly be a drop of the carbon structure's strength, and below this porosity range there may possibly be a decrease in the pores necessary for transmission and diffusion of an air or oxygen.

In order to obtain a battery capable of faster discharge with the carbon structure used as the positive electrode of a lithium air battery, the carbon structure may more preferably have (f) a porosity of 72% or more, 74% or more, 76% or more, or 78% or more. In order to add much higher strength to the carbon structure, on the other hand, the carbon structure may more preferably have (f) a porosity of 89% or less, 88% or less, 87% or less, or 86% or less.

### Manufacturing of the Carbon Structure

The inventive carbon structure may be manufactured by the process comprising:
preparing a mixed slurry containing a carbon material and a binding polymeric material;
molding the mixed slurry to obtain a mixed slurry molded assembly;
immersing the mixed slurry molded assembly in a solvent having a lower solubility for the binding polymeric material to obtain a porous structure;
drying the porous structure to obtain a carbon structure precursor; and
carbonizing the carbon structure precursor in an inert atmosphere to obtain a carbon structure.

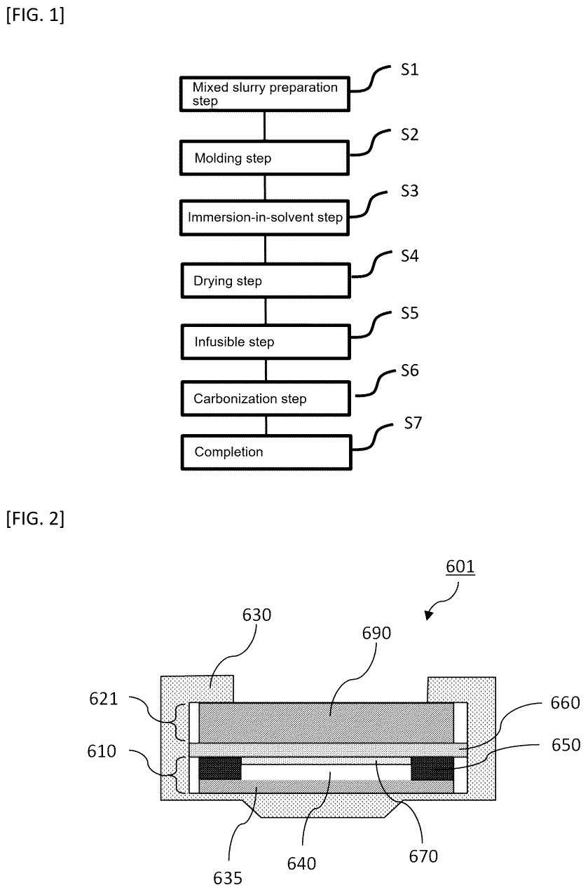

FIG. 1 is a flowchart showing the steps of manufacturing the inventive carbon structure.

First of all, a mixed slurry containing a carbon material and a binding polymeric material is prepared (Step S1).

The mixed slurry preferably comprises a carbon material in a solid mass percentage of 60% by mass to 95% by mass inclusive and a binder polymeric material in a solid mass percentage of 5% by mass to 40% by mass inclusive as well as a solvent capable of uniform dispersion of them.

The carbon material used for preparation of the mixed slurry is a carbon nanotube having the physical properties as mentioned above.

The binding polymeric material used for preparation of the mixed slurry may be exemplified by a polymeric material such as polyacrylonitrile (PAN), polysulfone, and a solvent-soluble polyimide.

The solvent used for preparation of the mixed slurry may be exemplified by dimethyl sulfoxide (DMSO), N-methylpyrrolidone (NMP), dimethylformamide (DMF) dimethylacetamide (DMA), and so on.

Then, the mixed slurry is molded to obtain a mixed slurry molded assembly (Step S2).

The molding process, on which there is no limitation imposed, may be exemplified by a wet filming process where a known doctor blade is used for coating as well as a roll coater process, a die coater process, a spin coating process, a spray coating process or the like.

The molded assembly may be formed in various shapes depending on the purposes, inclusive of a sheet shape having a uniform thickness.

Thereafter, the immersion-in-solvent step is carried out (Step S3). More specifically, the molded assembly obtained in Step S2 is immersed in a solvent having a lower solubility for the binding polymeric material to obtain a porous structure.

In this immersion-in-solvent step, the molded assembly obtained in Step S2 is immersed in a solvent having a lower solubility for the binding polymeric material by a nonsolvent inductive phase separation method so that the binding polymeric material is precipitated across the carbon material to bind up the carbon material, yielding a porous structure comprising the carbon material and the binding polymeric material.

For the solvent having a lower solubility for the binding polymeric material, there may be the mention of water, an alcohol such as ethyl alcohol, methyl alcohol and isopropyl alcohol, and a mixture thereof.

Then, drying is carried out (Step S4). More specifically, the porous structure obtained in Step S3 is dried to obtain a carbon structure precursor.

In this drying step, various solvents are volatilized out of the porous structure obtained in Step S3. Drying may be carried out by nonrestrictive processes such as a process carried out in a dried air environment, a reduced-pressure drying process, and a vacuum drying process. For an accelerated drying speed, heating may be carried out at a temperature slightly exceeding the boiling point of the solvent.

Then, the carbonization step is implemented (Step S6). More specifically, the carbon structure precursor obtained in Step S4 is carbonized in an inert atmosphere to obtain a carbon structure whereby the binding polymeric material is changed by polycondensation into carbon while the carbon material is strongly linked together by the resulting carbon. This carbonization process makes it possible to produce a self-supporting carbon structure.

The carbonization treatment or process is carried out in an inert gas atmosphere. Although not particularly limited, the furnace used for carbonization may be an oven furnace, a tubular furnace, a box furnace, an infrared irradiation furnace, a graphite heater furnace, an induction heating furnace, a lead hammer furnace, and an Acheson furnace.

The carbonization process may preferably be carried out in a temperature range of 500° C. to 3,000° C. inclusive, wherein there is good-enough carbonization achievable. More preferably, it is implemented in a range of 800° C. to 2,500° C. inclusive.

An upper limit on the heating speed during carbonization is preferably 100° C./min or less, more preferably 50° C./min or less, or most preferably 30° C./min or less. Exceeding this upper-limit heating speed may often render the carbon structure insufficient in terms of carbonization. While there is no particular lower limit on the heating speed, 0.01° C./min or higher makes cost performance better.

Carbonization is usually implemented in an inert atmosphere that may comprise an inert gas such as rare gas for instance argon (Ar) or nitrogen (N₂).

These steps ensure that a carbon structure having a self-supporting capability and, hence, a practically high mechanical strength can be produced. The aforesaid manufacturing process makes it possible to obtain a carbon structure comprising the molded assembly carbonized in its entirety, that is, a carbon structure having the self-supporting capability and electron conductivity needed for an electrode without recourse to any reinforcing material such as carbon fibers or a collector taking no direct part in battery reactions. The carbon structure obtained by the aforesaid manufacturing process does not only have a self-supporting capability but is also highly capable of air or oxygen permeation and ion transport, and serves as a wide reaction site when it is used as part of an air battery.

The inventive carbon structure manufacturing process may comprise an optional infusible step (Step S5). More specifically, subsequent to the step of drying the porous structure to obtain the carbon structure precursor (Step S4) and prior to the carbonization step (Step S6), the carbon structure precursor obtained in Step S4 may optionally be made infusible to obtain an infusible carbon structure. The infusible carbon structure obtained in the infusible step may then be carbonized thereby obtaining the end carbon structure.

This infusible step is carried out for the purpose of preventing the binding polymeric material from melting and separating in the next carbonization step thereby preventing the porous structure from being out of shape. More specifically, the binding polymeric material is oxidized and crosslinked for solidification in the infusible step thereby preventing the binding polymeric material from melting and separating in the next carbonization step.

The infusible step is implemented by heating in an oven furnace, heating by infrared irradiation or the like under an air flow. The treatment temperature, on which there is no particular limitation placed, is preferably 250° C. to 350° C. inclusive. Temperatures of higher than 250° C. allow oxidization and crosslinking of the binding polymeric material to proceed sufficiently so that the binding polymetric material can be prevented from melting in the next carbonization step. Temperatures of lower than 350° C. allow the polymeric material to be prevented from breaking down. This infusible step may be dispensed with depending on the type of the binding polymeric material used; it is an optional step in the inventive carbon structure manufacturing process.

### <<Positive Electrode for an Air Battery>>

The carbon structure according to the present invention may be used as a positive electrode for an air battery. The inventive carbon structure, because of having a self-supporting capability in itself, may be applied as the positive electrode just the way it is, with no need for any support such as a collector.

### <<Air Battery>>

The air battery according to the invention comprises a positive electrode designed for an air battery and containing such an inventive carbon structure as mentioned above, a negative electrode, and an electrolyte disposed between the positive electrode for the air battery and the negative electrode.

### <Coin Cell Type Air Battery>

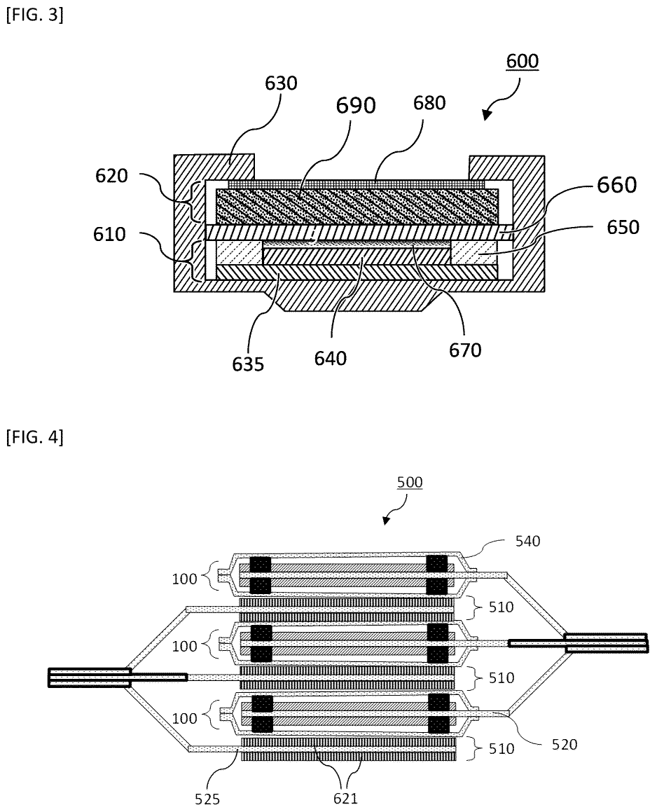

FIG. 2 is a schematic sectional view of an air battery according to one embodiment of the invention, and FIG. 3 is a schematic sectional view of an air battery according to another embodiment of the invention. An air battery 601, generally called a “coin cell type”, comprises an electrode stack or assembly wherein a negative electrode structure 610 and a positive electrode structure 621 are stacked one upon another via a separator 660, and a holder 630 adapted to hold the electrode assembly in place.

In the air battery 601 shown in FIG. 2, the positive electrode structure 621 is provided as such by a carbon structure 690 according to the invention, only which is provided as the positive electrode structure 621. The inventive carbon structure, because of having a self-supporting capability, may be used alone as the positive electrode structure.

The positive electrode structure 621 of FIG. 2 composed only of the carbon structure 690 allows the air battery 601 to have a high mass energy density because of being free of a metal mesh or the like forming a collector. The carbon structure 690, because of being simplified in construction, enables to reduce the number of production steps thereby producing an air battery with high efficiencies.

An insulating O-ring (not shown) is disposed between the holder 630 and the carbon structure 690 providing the positive electrode structure 690 to ensure insulation between the holder 630 and the positive electrode structure 621.

The negative electrode structure 610 comprises a collector 635, a metal layer 640 disposed on the collector 635, and a spacer 650 arranged on the collector 635 in such a way as to surround the outer periphery of the metal layer 640. Between the metal layer 640 and a separator 660 there is a space 670 provided, in which an electrolyte is filled up.

The material forming the metal layer 640 preferably contains an alkaline metal and/or an alkaline earth metal, and particular preference is given to a layer containing a lithium metal.

The separator 660 is located between the negative electrode structure 610 and the positive electrode structure 621.

An air battery according to another embodiment of the invention is shown in FIG. 3. The air battery 600 of FIG. 3 comprises a positive electrode structure 620 composed of an inventive carbon structure 690 and a metal mesh 680. Referring more specifically to the positive electrode structure 620 of the air battery 600, the inventive carbon structure 690 is in mechanical and electrical connection with the metal mesh 680 that does not only serve as an air or oxygen passage but also functions as a collector.

Only a difference between the air battery 601 of FIG. 2 and the air battery 600 of FIG. 3 is whether or not the metal mesh 680 is used. Although the inventive carbon structure may provide a positive electrode structure by itself owing to its self-supporting capability, it may further comprise a collector such as a metal mesh depending on the physical characteristics demanded for air batteries.

The positive electrode structure 620 of FIG. 3, combined with the metal mesh 680 present there, makes electrical conductivity high and ensures a sufficient air or oxygen passage, providing an air battery well fit for high outputs.

It is here noted that an insulating O-ring (not shown) is disposed between the holder 630 and the metal mesh 680 to ensure insulation between the holder 630 and the positive electrode structure 620.

There is a separator 660 disposed between the negative electrode structure 610 and the positive electrode structure 620.

In what follows, one example of producing the air battery 601 will be explained. First of all, a negative electrode structure 610 is provided. On a disk-shaped collector 635 there is a disk-shaped lithium or other metal layer 640 laminated or stacked, which layer is concentric with and is smaller in diameter than the collector 635. Subsequently, a spacer 650 is pressed on the periphery of the metal layer 640 on the collector 635 to obtain the negative electrode structure 610.

The spacer 650 is an insulator that may be formed of a material such as a metal oxide, a metal nitride, and a metal oxynitride exemplified by Al₂O₃, Ta₂O₅, TiO₂, Zno, ZrO₂, SiO₂, B₂O₃, P₂O₅, GeO₂, Li₂O, Na₂O, K₂O, MgO, Cao, Sro, Bao, Si₃N₄, AlN, and AlOₓN₁₋ₓ (0<x<1), among which Al₂O₃, and SiO₂ is preferable thanks to its availableness and enhanced processability.

The spacer 650 may also be a resin exemplified by a polyolefin-based resin, a polyester-based resin, a polyimide-based resin, and a polyether ether ketone (PEEK)-based resin. The polyolefin-based resin includes polyethylene, and polypropylene; the polyester-based resin includes polyethylene terephthalate (PET), polybutylene terephthalate (PBT), polyethylene naphthalate (PEN), and polytributylene terenaphthalate (PTT). These resins are preferable thanks to their availableness and enhanced processability.

Then, the separator 660 is pressed onto the spacer 650. It is here preferable to locate a space 670 between the metal layer 640, spacer 650, and separator 660.

The separator 660 is a porous insulator through which alkaline metal ions and/or alkaline earth metal ions can pass. The separator 660 may be formed of an arbitrary inorganic material (including a metal material), and an organic material having no reactivity to the metal layer 640, and an electrolyte.

Any separator applied to existing metal batteries may be used as the separator 660; for instance, there is the mention of a porous film comprising a synthetic resin like a polyolefin such as polyethylene and polypropylene, and a sheet comprising glass fibers, and the like. The separator 660 may also be formed of a woven or unwoven fabric.

Thereafter, an electrolyte is filled up in the separator 660. It is here preferable that the space 670 is also filled with the electrolyte.

Aqueous or nonaqueous arbitrary electrolytes containing an alkaline metal salt and/or an alkaline earth metal salt may be used as the electrolyte.

When the aqueous electrolyte contains a lithium salt as the alkaline metal salt and/or alkaline earth metal salt, for instance, LiOH, LiCl, LiNO₃, and Li₂SO₄ may be used as the lithium salt, and water or a water-soluble solvent may be used as the solvent.

When the nonaqueous electrolyte (non-water electrolyte) contains a lithium salt as the alkaline metal salt and/or alkaline earth metal salt, for instance, LiPF₆, LiBF₄, LiSbF₆, LiSiF₆, LiAsF₆, LiN(SO₂C₂F₅)₂, Li(FSO₂)₂N, LiCF₃SO₃(LiTfO), Li(CF₃SO₂)₂N(LiTFSI), LiC₄F₉SO₃, LiClO₄, LiAlO₂, LiAlCl₄, and LiB(C₂O₄)₂ may be used as the lithium salt.

For instance, the non-water solvent used with the nonaqueous electrolyte includes glymes (monoglyme, diglyme, triglyme, tetraglyme), methyl butyl ether, diethyl ether, ethyl butyl ether, dibutyl ether, polyethylene glycol dimethyl ether, tetraethylene glycol dimethyl ether, cyclohexanone, dioxane, dimethoxyethane, 2-methyltetrahydrofuran, 2,2-dimethyltetrahydrofuran, 2,5-dimethyltetrahydrofuran, tetrahydrofuran, methyl acetate, ethyl acetate, n-propyl acetate, dimethyl acetate, methyl propionate, ethyl propionate, methyl formate, ethyl formate, dimethyl carbonate, diethyl carbonate, ethyl methyl carbonate, dipropyl carbonate, methyl propyl carbonate, ethyl propyl carbonate, ethylene carbonate, propylene carbonate, butylene carbonate, polyethylene carbonate, γ-butyrolactone, decanolide, valerolactone, mevalonolactone, caprolactone, acetonitrile, benzonitrile, nitromethane, nitrobenzene, triethylamine, triphenylamine, tetraethylene glycol diamine, dimethylformamide, diethylformamide, N-methyl-pyrrolidone, dimethyl sulfone, tetramethylene sulfone, triethyl phosphine oxide, 1,3-dioxolane, and sulfolane.

Thereafter, the inventive carbon structure 690 that is the positive electrode structure 621 is bonded to the negative electrode structure 610 filled up by an electrolyte via the separator 660, and the resulting assembly is held in place by a coin cell type holder 630 to obtain an air battery 601. Implementation is preferably carried out in a dried air, for example, a dried air having a dew point of −50° C. or lower.

When the air battery 600 of FIG. 3 is prepared, the aforesaid implementation is carried out by use of the positive electrode structure 620 having the metal mesh 680 disposed on the carbon structure 690.

A mesh containing at least one metal selected from the group consisting of, for instance, copper (Cu), tungsten (W), aluminum (Al), nickel (Ni), titanium (Ti), gold (Au), silver (Ag), platinum (Pt), and palladium (Pd) may be used as the metal mesh 680. For instance, there may be the mention of a mesh comprising a single metal selected from this group, an alloy containing a metal selected from this group, and a compound of a metal selected from this group with carbon (C), nitrogen (N) and the like. The alloy may contain iron (Fe), and chromium (Cr), and the mesh may have a thickness of 0.2 mm and an aperture of 1 mm.

The air battery 601, and 600 is capable of taking in a large amount of oxygen due to an enhanced air or oxygen permeability of the positive electrode structure using the inventive carbon structure. In addition, there is high ion transport efficiency and a wide reaction site as well as a simple structure composed only of a carbon structure or a carbon structure and a metal mesh, allowing the air battery to be reduced in size and weight and fit for increased capacities.

### <Stacked Air Battery>

FIG. 4 is a schematic sectional view of an air battery according to another embodiment of the invention. FIG. 4 is a schematic view of a stacked air battery (stacked metal battery).

An air battery 500 comprises a stacked structure wherein a positive electrode stack 510 and a negative electrode stack 100 are stacked one upon another via a separator 540. The number of stacks may be one or more pairs provided that one pair comprises one positive electrode stack 510 and one negative electrode stack 100, with no particular upper limit on the number of pairs.

The negative electrode stack 100 comprises a pair of negative electrode active material layers (metal layers) and a negative electrode collector 520 sandwiched there-between.

On the other hand, the positive electrode stack 510 comprises a pair of inventive carbon structures or positive electrode structure 621 and a positive electrode collector 525 sandwiched therebetween. In the air battery 500, the positive electrode collector 525 also serves as an air or oxygen passage.

The inventive carbon structure, because of having a self-supporting capability, allows the positive electrode structure 510 in the stacked air battery 500 to be formed by arranging the positive electrode collector 525 between the positive electrode structures provided by the inventive carbon structures themselves. Therefore, the stacked air battery can be assembled in a simple stacked construction with much more capacities.

It is here understood that while the inventive carbon structures are immediately used as the positive electrode structures in the air battery 500, the positive electrode structures may be obtained by stacking the inventive carbon structure upon a collector such as a metal mesh. The inventive carbon structure, because of having a self-supporting capability, may provide a positive electrode structure in itself, but may further comprise a collector such as a metal mesh depending on the physical properties demanded for an air battery.

At least one metal selected from the group consisting of, for instance, copper (Cu), tungsten (W), nickel (Ni), titanium (Ti), gold (Au), silver (Ag), platinum (Pt), and palladium (Pd) may be used as the negative electrode collector 520.

At least one metal selected from the group consisting of, for instance, stainless steel (SUS), tungsten (W), aluminum (Al), nickel (Ni), titanium (Ti), gold (Au), silver (Ag), platinum (Pt), and palladium (Pd) may be used as the positive electrode collector 525.

In other words, the negative electrode collector 520, and the positive electrode collector 525 may be formed of, for instance, a single metal selected from this group, an alloy containing a metal selected from this group, and a compound of a metal selected from this group with carbon (C), nitrogen (N) and the like.

It is here understood that the positive electrode collector 525, because of serving as an air or oxygen passage, must be formed of a porous material such as a mesh, a grid or a sponge.

The air battery 500 may be produced by stacking the negative electrode structure 100 and the positive electrode structure 510 one upon another via the separator 540. The air battery 500 may be received in a container (not shown).

The air battery 500 is capable of taking in a large amount of oxygen due to an enhanced air or oxygen permeability of the positive electrode structure 510 using the inventive carbon structure. In addition, there is high ion transport efficiency and a wide reaction site as well as a simple structure composed only of a carbon structure or a carbon structure and a metal mesh, allowing the air battery to be reduced in size and weight and fit for increased capacities.

### EXAMPLES

The present invention is now set forth in further details with reference to the examples or the like; however, the present invention is not limited thereto.

### <Measuring Methods>

The physical properties of the carbon materials used as the starting materials and the carbon structures prepared therefrom were measured by the following methods.

### (1) Pore Volume Taken Up by Pores Having a Diameter of 1 nm to 1,000 nm Inclusive

Using 3Flex (Micromeritics Instrument Corp.), the pore volume was found from an adsorption isotherm obtained by a nitrogen adsorption method by use of the BJH method (Barrett-Joyner-Hallenda).

### (2) Pore Volume Taken Up by Pores Having a Diameter of 1 nm to 200 Nm Inclusive

Using 3Flex (Micromeritics Instrument Corp.), the pore volume was found from an adsorption isotherm obtained by a nitrogen adsorption method by use of the BJH method.

### (3) Pore Volume Taken Up by Pores Having a Diameter of 200 nm to 1,000 nm Inclusive

Using 3Flex (Micromeritics Instrument Corp.), the pore volume was found from an adsorption isotherm obtained by a nitrogen adsorption method by use of the BJH method.

### (4) BET Specific Surface Area

Using 3Flex (Micromeritics Instrument Corp.), the specific surface area was found from an adsorption isotherm obtained by a nitrogen adsorption method, according to the BET (Barrett-Emmett-Teller) method.

(5) t-Plot Outer Specific Surface Area

Using 3Flex (Micromeritics Instrument Corp.), the outer specific surface was found from a graph with the thickness of the nitrogen adsorption layer as abscissa and the amount of nitrogen adsorbed as ordinate by the t-plot method, based on an adsorption isotherm obtained by a nitrogen adsorption method.

(6) t-Plot Micropore Specific Surface Area

This specific surface area is defined by a value obtained by subtracting the t-plot outer specific surface area from the BET method specific surface area.

### (7) Pore Volume Taken Up by Pores Having a Diameter of 200 nm to 10,000 nm Inclusive

Pore volumes in a pore diameter range of 10 nm to 200,000 nm (0.01 μm to 200 μm) inclusive were measured by a mercury intrusion method using AutoPore IV (Micromeritics Instrument Corp.), and a pore volume value of pores having a diameter of 200 nm to 10,000 nm was used.

### (8) Apparent Density

The apparent density was found by dividing the mass of a carbon structure by its volume.

### (9) Porosity

The porosity was found according to the following equation:

$$( 1 - apparent density of carbon structure / true density of carbon structure ) \times 100.$$

### <Carbon Materials>

The carbon materials used as the starting materials for the inventive carbon structure are shown in Table 1.

TABLE 1

| | | CNT1 | CNT2 | KB | CNT3 | CNT4 |
|---|---|---|---|---|---|---|
| Material No. | | TUBALL-CNT | Meijo CNT | Ketchen Black | ZEON-CNT | Cnano-CNT |
| [symbol] | | 01RW03 | eDIPS-ECP2.0 | 600-JD | SG101 | FT6120 |
| Average diameter | (nm) | 1.6 | 2 | — | 4 | 8 |
| Average lengrh | (μm) | 5 | 10 | — | 400 | 150 |
| Average aspect ratio | | 3,100 | 5,000 | — | 100,000 | 19,000 |
| (length/diameter) | | | | | | |
| Primary particle | (nm) | — | — | 34 | — | — |
| diameter | | | | | | |
| D50% particle | (μm) | — | — | 4.2 | — | — |
| diameter | | | | | | |
| Pore volume taken | (cm³/g) | 1.4 | 0.8 | 3.6 | 5.9 | 2.3 |
| up by pores having | | | | | | |
| a diameter of 1 nm | | | | | | |
| to 1,000 nm | | | | | | |
| (BJH method) | | | | | | |
| Pore volume taken | (cm³/g) | 1.2 | 0.8 | 2.6 | 5.9 | 2.0 |
| up by pores having | | | | | | |
| a diameter of 1 nm | | | | | | |
| to 200 nm | | | | | | |
| (BJH method) | | | | | | |
| Pore volume taken | (cm³/g) | 0.2 | 0.0 | 1.0 | 0.0 | 0.3 |
| up by pores having | | | | | | |
| a diameter of | | | | | | |
| 200 nm to 1000 nm | | | | | | |
| (BJH method)) | | | | | | |
| Specific surface | (m²/g) | 913 | 423 | 1328 | 1383 | 303 |
| area as measured | | | | | | |
| by the BET method | | | | | | |
| t-plot outer | (m²/g) | 302 | 325 | 1130 | 994 | 287 |
| specific surface | | | | | | |
| area (mesopore + | | | | | | |
| macropore specific | | | | | | |
| surface area | | | | | | |
| t-plot micropore | (m²/g) | 611 | 98 | 198 | 390 | 16 |
| specific surface | | | | | | |
| area | | | | | | |

### Example 1

### (Carbon Material)

A carbon nanotube “TUBALL-CNT 01RWO3 (OCSiAl corp.) (CNT1) was used as the carbon material. As shown in Table 1, TUBALL-CNT 01RWO3 has an average diameter of 1.6 nm, an average length of 5 μm, and an aspect ratio of 3,100.

### [Preparation of the Carbon Structure]

### (Mixed Slurry Preparation Step)

80 parts by mass of TUBALL-CNT 01RWO3 and 20 parts by mass of polyacrylonitrile (PAN) acting as the binding polymeric material were added with N-methylpyrrolidone as a solvent for uniform dispersion of these, followed by mixing with use of a planetary centrifugal kneader (Model ARE310 available from Thinky Corp.) to prepare a mixed slurry.

### (Molding Step)

The mixed slurry was coated at a thickness of 300 μm by doctor blading to prepare a mixed slurry molded sheet (mixed slurry molded assembly).

### (Immersion-In-Solvent Step)

The mixed slurry molded sheet obtained in the molding step was immersed in methanol (poor solvent) to obtain a porous film by a nonsolvent inductive phase separation method.

It is here understood that the nonsolvent inductive phase separation method comprises immersing a polymeric solution in a nonsolvent for phase separation of the polymeric material. In this example, the mixed slurry molded sheet obtained by molding the mixed slurry wherein the carbon material is dispersed in the N-methylpyrrolidone solution having polyacrylonitrile (PAN), the binder polymeric material, dissolved therein is immersed in the nonsolvent (poor solvent) methanol so that N-methylpyrrolidone is eluted into methanol, resulting in precipitation of polyacrylonitrile (PAN) between the carbon materials. In turn, a porous structure having a carbon material skeleton is formed.

Referring specifically to the immersion-in-solvent step, the mixed slurry molded sheet was placed in a tray, and 220 g of methanol were charged therein. Two hours later, methanol was drained out of the tray whereupon 220 g of new ethanol were charged, followed by standing for 17 hours. Thereafter, methanol was drained out of the tray to obtain a phase-separation sheet (porous structure) comprising a porous film.

### (Drying Step)

The phase-separation sheet (porous structure) comprising a porous film was removed from the tray, and dried at 50° C. for two hours and then at 80° C. for 10 hours for removal of any volatile solvent contained in the phase-separation sheet (porous structure) to obtain a dried sheet (carbon structure precursor).

### (Infusible Step)

Using Yamato Inert Oven DN411, the resulting dried sheet (carbon structure precursor) was subjected to infusible heat treatment at 320° C. for 3 hours in an air circulation atmosphere to change polyacrylonitrile (PAN) in the dried sheet (carbon structure precursor) into an infusible resin via oxidative crosslinking and cyclization to obtain an infusible sheet (infusible carbon structure) of 90 mm in length and 80 mm in width.

### (Carbonization Step)

Using a box type furnace (available from Denken-Highdental Co., Ltd.), the infusible sheet (infusible carbon structure) obtained in the infusible step was heated up to 1,050° C. at a heating speed of 10° C./min in a nitrogen gas flowing at 600 mL/min, and held at 1,050° C. for 3 hours, followed by cooling down to room temperatures, thereby carbonizing the infusible polyacrylonitrile (PAN) to obtain a porous carbon structure comprising total carbon. The production conditions and production results are set out in Table 2.

TABLE 2

| | | | Mixed composition | | | | |
|---|---|---|---|---|---|---|---|
| | | | (mixed slurry preparation step) | | | | |
| | | | | | Binding | Molding | Immersion-in- |
| | | | Carbon | Carbon | polymeno | step | solvent step |
| | | | material | fibers | material | Coating | State of the |
| | | | (Parts by | (Parts by | (Parts by | thickness | phase-seperation |
| | Carbon material | | mass) | mass) | mass) | (μm) | sheet |
| Exemple 1 | TUBAL-CNT | CNT1 | 80 | — | 20 | 300 | Film shape kept |
| | 01 RW03 | | | | | | |
| Example 2 | TUBAL-CNT | CNT1 | 90 | — | 10 | 300 | Film shape kept |
| | 01 RW03 | | | | | | |
| Example 3 | Meijo CNT | CNT2 | 80 | — | 20 | 550 | Film shape kept |
| | eDIPS-ECP2.0 | | | | | | |
| Comparative | Ketchen Black | KB | 80 | — | 20 | 300 | Brittle, failing to |
| Example 1 | 600-JD | | | | | | keep film shape |
| Comparative | Ketchen Black | KB | 65 | 12 | 23 | 300 | Film shape kept |
| Example 2 | 600-JD | | | | | | |
| Comparative | ZEON-CNT | CNT3 | 80 | — | 20 | 300 | Sea island |
| Example 3 | SG101 | | | | | | incapable of |
| | | | | | | | showing film |
| | | | | | | | shape |
| Comperative | Cnano-CNT FT6120 | CNT4 | 80 | — | 20 | 300 | Brittle, failing to |
| Example 4 | | | | | | | keep film shape |
| Comparetive | Cnano-CNT FT6120 | CNT4 | 75 | 10 | 15 | 300 | Film shape kept |
| Example 5 | | | | | | | |

| | | | | Thickness of | |
|---|---|---|---|---|---|
| | Carbonization step | | | the carbon | State of |
| | Temperature | Hold time | Yields | structure | the carbon |
| | (° C.) | (hr) | (mass %) | (μm) | structure |
| Exemple 1 | 1050 | 3 | 85 | 200 | Carbon |
| | | | | | structure |
| | | | | | capable of |
| | | | | | keeping shape |
| Example 2 | 1050 | 3 | 89 | 65 | Carton |
| | | | | | structure |
| | | | | | capable of |
| | | | | | keeping shape |
| Example 3 | 1050 | 3 | 85 | 60 | Carbon |
| | | | | | structure |
| | | | | | capable of |
| | | | | | keeping shape |
| Comparative | — | — | — | — | — |
| Example 1 | | | | | |
| Comparative | 1050 | 3 | 82 | 150 | Carbon |
| Example 2 | | | | | structure |
| | | | | | capable of |
| | | | | | keeping shape |
| Comparative | — | — | — | — | — |
| Example 3 | | | | | |
| Comperative | — | — | — | — | — |
| Example 4 | | | | | |
| Comparetive | 1050 | 3 | 88 | 220 | Carbon |
| Example 5 | | | | | structure |
| | | | | | capable of |
| | | | | | keeping shape |

### [Measurement of the Physical Properties of the Carbon Structure]

The resulting carbon structures were measured in terms of various physical characteristics. The pore volume taken up by pores having a diameter of 1 nm to 1,000 nm inclusive was 1.2 cm³/g; the pore volume taken up by pores having a diameter of 1 nm to 200 nm inclusive was 1.1 cm³/g; the pore volume taken up by pores having a diameter of 200 nm to 10,000 nm inclusive was 2.9 cm³/g; and the t-plot outer specific surface area was 161 m²/g. The basis weight (mg/cm²) was found by punching out the carbon structure to a diameter of 16 mm (16φ) and dividing its mass by its area. The physical properties of the carbon structures are set out in Table 3.

TABLE 3

| | | | | | Comparative | Comparative |
|---|---|---|---|---|---|---|
| | | Example 1 | Example 2 | Example 3 | Example 2 | Example 5 |
| Carbon material | | TUBAL-CNT | TUBAL-CNT | Meijo CNT | Ketchen Black | Cnano-CNT |
| | | 01RW03 | 01RW03 | eDIPS-ECP2.0 | 600-JD | FT6120 |
| | | CNT1 | CNT1 | CNT2 | KB | CNT4 |
| Pore volume taken up | (cm³/g) | 1.2 | 1.4 | 2.6 | 3.3 | 2.6 |
| by pores having a | | | | | | |
| diameter of 1 nm to | | | | | | |
| 1,000 nm | | | | | | |
| (BJH method) | | | | | | |
| Pore volume taken up | (cm³/g) | 1.1 | 1.0 | 2.1 | 2.1 | 2.1 |
| by pores having a | | | | | | |
| diameter of 1 nm to | | | | | | |
| 200 nm | | | | | | |
| (BJH method) | | | | | | |
| Pore volume taken up | (cm³/g) | 2.9 | 1.6 | 1.1 | 1.7 | 3.4 |
| by pores having a | | | | | | |
| diameter of 200 nm to | | | | | | |
| 10,000 nm | | | | | | |
| (mercury intrusion | | | | | | |
| method) | | | | | | |
| Specific surface area | (m²/g) | 343 | 367 | 301 | 808 | 219 |
| as measured by the | | | | | | |
| BET method | | | | | | |
| t-plot outer specific | (m²/g) | 161 | 188 | 219 | 773 | 199 |
| surface area | | | | | | |
| t-plot micropore | (m²/g) | 181 | 178 | 82 | 35 | 20 |
| specific surface area | | | | | | |
| Apparent density | (g/cm²) | 0.17 | 0.26 | 0.26 | 0.18 | 0.15 |
| Porosity | (%) | 88 | 82 | 81 | 92 | 90 |
| Basis weight | (mg/cm²) | 3.2 | 1.6 | 1.6 | 2.7 | 3.3 |
| Discharge capacity | (mAh/g) | 3476 | 4219 | 4928 | 2824 | 1976 |

### [Preparation of the Lithium Air Battery]

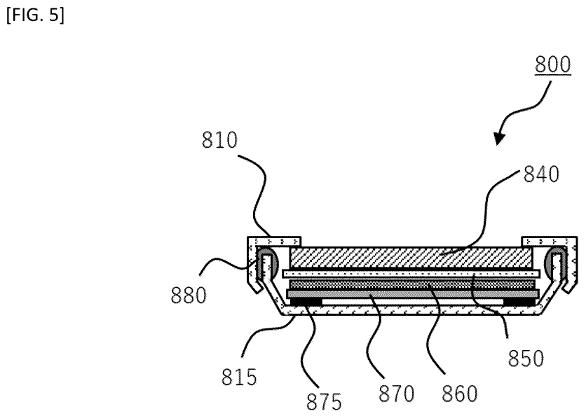

The carbon structure was punched out to a diameter of 16 mm (16 φ), and the thus obtained carbon structure having a diameter of 16 mm (16 φ) was used as a positive electrode to prepare a CR2032 type coin cell 800 shown in FIG. 5.

More specifically, the coin cell was prepared by assembling or packing a positive electrode 840 provided by a carbon structure having a diameter of 16 mm (φ16), a negative electrode 860 provided by metal lithium (having a diameter of 16 mm (φ16) and a thickness of 0.2 mm), a separator (glass fiber paper (Whatman™ GF/A) 850 impregnated with 100 μL of 1M-tetraethylene glycol dimethyl ether solution of LiTFS (lithium trifluoro-methanesulfonate) as an electrolyte, a stainless disc 870 and a dish spring 875 in a coin cell can (a positive electrode can 810 and a negative electrode can 815) (CR2032 type) in a dry room (dry air) in a range of dew point temperature to −50° C. or lower. In FIG. 5, a gasket 880 is sandwiched between the positive electrode can 810 and the negative electrode can 815 to make sure of fixation and insulation of the positive electrode can 810 and the negative electrode can 815. An outside air (oxygen herein) is directly taken in the positive electrode 840.

### [Measurement of the Discharge Capacity]

The coin cell as the thus prepared lithium air battery was measured in terms of discharge capacity at a current density of 0.4 mA/cm² in a pure oxygen atmosphere. With the discharge end point defined by a voltage going down to 2.3 V, the resulting discharge capacity was divided by the mass of the carbon structure used as the positive electrode to find a discharge capacity (specific capacity) per positive electrode mass. Consequently, the discharge capacity per positive electrode mass was 3,476 mAh/g. The discharge capacities are set out in Table 3.

### Example 2

### (Carbon Material)

The same carbon material (CNT1) as in Example 1 was used.

### [Preparation of the Carbon Structure]

### (Mixed Slurry Preparation Step)

A mixed slurry was prepared as in Example 1 with the exception that 90 parts by mass of TUBALL-CNT 01RW03 (CNT1) and 10 parts by mass of the binding polymeric material polyacrylonitrile (PAN) were used.

### (Molding Step), (Immersion-In-Solvent Step), (Drying Step), (Infusible Step), and (Carbonization Step)

The molding step, immersion-in-solvent step, drying step, infusible step and carbonization step were carried out as in Example 1 to obtain a carbon structure. The production conditions and production results are shown in Table 2.

### [Measurement of the Physical Properties of Carbon Structures]

The resultant carbon structures were measured in terms of various physical properties as in Example 1, and the results are shown in Table 3.

### [Measurement of the Discharge Capacity]

A lithium air battery was prepared as in Example 1, and measured in terms of discharge capacity. The discharge capacity per positive electrode mass was 4,219 mAh/g. The results are set out in Table 3.

### Example 3

### (Carbon Material)

A carbon nanotube “eDIPS EC2.0P” (made by Meijo Nano Carbon Co., Ltd.) (CNT2) was used as the carbon material. As shown in Table 1, “eDIPS EC2.0P” has an average diameter of 2 nm, an average length of 10 μm, and an aspect ratio of 5,100.

### [Preparation of the Carbon Structure]

### (Mixed Slurry Preparation Step), (Molding Step), (Immersion-In-Solvent Step), (Drying Step), (Infusible Step), and (Carbonization Step)

With the exception that “eDIPS EC2.0P” (CNT2) was used as the carbon material and a coating thickness of 550 μm was used in the molding step, the mixed slurry preparation step, molding step, immersion-in-solvent step, drying step, infusible step and carbonization step were carried out as in Example 1 to obtain a carbon structure. The production conditions and production results are set out in Table 2.

### [Measurement of the Physical Properties of the Carbon Structure]

The resultant carbon structure was measured in terms of various physical properties as in Example 1. The results are set out in Table 3.

### [Measurement of the Discharge Capacity]

A lithium air battery was prepared as in Example 1 to measure its discharge capacity. The discharge capacity per positive electrode mass was 4,928 mAh/g. The results are shown in Table 3.

### Comparative Example 1

### (Carbon Material)

“Ketchen Black EC600JD” (made by Lion Specialty Chemicals Co., Ltd.) (KB) was used as the carbon material. “Ketchen Black EC600JD” (KB) provides secondary particles wherein carbon particles having a primary particle diameter of about 34 nm are bound together into a bunch of grapes, and has a particle diameter of 4.2 μm in terms of 50% particle diameter, as shown in Table 1 together with other features. It is here understood that the 50% particle diameter was measured using a laser particle size distribution meter LA950V2 (made by Horiba, Ltd.) with ethanol as dispersant, after 3-minute dispersion at a circulation speed of 3 and an ultrasonic strength of 7, and expressed as an integral particle size value of 50% on a volume basis.

### [Preparation of the Carbon Structure]

### (Mixed Slurry Preparation Step), (Molding Step), and (Immersion-In-Solvent Step)

With the exception that “Ketchen Black EC600JD” (KB) was used as the carbon material, the mixed slurry preparation step, molding step and immersion-in-solvent step were carried out as in Example 1. However, the phase-separation sheet (porous structure) obtained in the immersion-in-solvent step was so poor in strength that it ruptured during handling, failing to go to the next drying step. The production conditions and production results are shown in Table 2.

### Comparative Example 2

### (Starting Material)

The same “Ketchen Black EC600JD” made by Lion Specialty Chemicals Co., Ltd. (KB) as in Comparative Example 1 was used as the carbon material.

### [Preparation of the Carbon Structure]

### (Mixed Slurry Preparation Step)

A mixed slurry was prepared as in Example 1 with the exception that 65 parts by mass of “Ketchen Black EC600JD” (KB), 12 parts by mass of carbon fibers as a reinforcing material, and 23 parts by mass of polyacrylonitrile (PAN) as a binding polymeric material were used. The carbon fibers used as a reinforcing material were chopped fibers (made by Nippon Polymer Sangyo Co., Ltd. with an average diameter of 6 μm and an average length of 3 mm).

### (Molding Step), (Immersion-In-Solvent Step), (Drying Step), (Infusible Step), and (Carbonization Step)

The molding step, immersion-in-solvent step, drying step, infusible step, and carbonization step were carried out as in Example 1 to obtain a carbon structure. The production conditions and production results are shown in Table 2.

It is here noted that because the carbon fibers were not added as the reinforcing material in Comparative Example 1, the phase-separation sheet (porous structure) obtained in the immersion-in-solvent step was so poor in strength that it ruptured. In Comparative Example 2, however, the phase-separation sheet (porous structure) with strength held was obtained because of addition of carbon fibers as a reinforcing material.

### [Measurement of the Physical Properties of the Carbon Structure]

The resultant carbon structure was measured in terms of various physical properties as in Example 1. The results are set out in Table 3.

### [Measurement of the Discharge Capacity]

A lithium air battery was prepared as in Example 1 to measure its discharge capacity. The discharge capacity per positive electrode mass was 2,824 mAh/g. The results are shown in Table 3.

### Comparative Example 3

### (Carbon Material)

A carbon nanotube “ZEON-CNT-SG101” made by Zeon Corporation (CNT3) was used as the carbon material. ZEON-CNT-SG101 has an average diameter of 4 nm, an average length of 400 μm, and an aspect ratio of 100,000, as shown in Table 1.

### [Preparation of the Carbon Structure]

### (Mixed Slurry Preparation Step), (Molding Step), and (Immersion-In-Solvent Step)

With the exception that ZEON-CNT-SG101 (CNT3) was used as the carbon material, the mixed slurry preparation step, molding step and immersion-in-solvent step were carried out as in Example 1. However, the phase-separation sheet (porous structure) obtained in the immersion-in-solvent step remained in a mottled pattern and sea-island state and was poor in strength, failing to go to the next step. The production conditions and production results are shown in Table 2.

### Comparative Example 4

### (Carbon Material)

A carbon nanotube “Cnano-CNT FT6120” made by Jiangsu Cnano Technology Co., Ltd. (CNT4) was used as the carbon material. Cnano-CNT FT6120 has an average diameter of 8 nm, an average length of 150 μm, and an aspect ratio of 19,000, as shown in Table 1.

### [Preparation of the Carbon Structure]

### (Mixed Slurry Preparation Step), (Molding Step), and (Immersion-In-Solvent Step)

With the exception that the carbon nanotube “Cnano-CNT FT6120” (CNT4) was used as the carbon material, the mixed slurry preparation step, molding step and immersion-in-solvent step were carried out as in Example 1. However, the phase-separation sheet (porous structure) obtained in the immersion-in-solvent step was so poor in strength that it ruptured during handling, failing to go to the next drying step. The production conditions and production results are shown in Table 2.

### Comparative Example 5

### [Carbon Material]

The same carbon nanotube “Cnano-CNT FT6120” made by Jiangsu Cnano Technology Co., Ltd. (CNT4) as in Comparative Example 4 was used as the carbon material.

### (Mixed Slurry Preparation Step)

### [Preparation of the Carbon Structure]

A mixed slurry was prepared as in Example 1 with the exception that 75 parts by mass of “Cnano-CNT FT6120”, 10 parts by mass of carbon fibers as a reinforcing material, and 15 parts by mass of polyacrylonitrile (PAN) as a binding polymeric material were used. The carbon fibers used as a reinforcing material were chopped fibers (made by Nippon Polymer Sangyo Co., Ltd. with an average fiber diameter of 6 μm and an average length of 3 mm).

### (Molding Step), (Immersion-In-Solvent Step), (Drying Step), (Infusible Step), and (Carbonization Step)

The molding step, immersion-in-solvent step, drying step, infusible step, and carbonization step were carried out as in Example 1 to obtain a carbon structure. The production conditions and production results are shown in Table 2.

It is here noted that because the carbon fibers were not added as the reinforcing material in Comparative Example 4, the phase-separation sheet (porous structure) obtained in the immersion-in-solvent step was so poor in strength that it ruptured. In Comparative Example 5, however, the phase-separation sheet (porous structure) with strength held was obtained because of addition of carbon fibers as a reinforcing material.

### [Measurement of the Physical Properties of the Carbon Structure]

The resultant carbon structure was measured in terms of various physical properties as in Example 1. The results are set out in Table 3.

### [Measurement of the Discharge Capacity]

A lithium air battery was prepared as in Example 1 to measure its discharge capacity. The discharge capacity per positive electrode mass was 1, 976 mAh/g. The results are shown in Table 3.

### INDUSTRIAL APPLICABILITY

According to the inventive carbon structure, it is possible to realize an air battery that is small in size and weight, and has an increased discharge capacity. The inventive carbon structure is produced without recourse to any carbonization step in an oxidizing gas atmosphere so that an air battery having an increased discharge capacity can be more easily produced at a lower product cost as compared with a carbon structure produced via a carbonization step in an oxidizing gas atmosphere.

### EXPLANATION OF THE REFERENCE NUMERALS

600, 601: air battery
610: negative electrode structure
620, 621: positive electrode structure
630: holder
635: collector
640: metal layer
650: spacer
660: separator
670: space
680: metal mesh
500: air battery
100: negative electrode stack
510: positive electrode stack
520: negative electrode collector
525: positive electrode collector
540: separator
800: coin cell
810: positive electrode can
815: negative electrode can
840: positive electrode
850: separator
860: negative electrode
870: disc
875: dish spring
880: gasket

1. A carbon structure for a positive electrode of an air battery, which comprises a carbon nanotube as a carbon material wherein said carbon nanotube has an average diameter of 1 nm to 10 nm inclusive, an average length of 1 μm to 100 μm inclusive, and an aspect ratio of 1,000 to 10,000 inclusive.

2. The carbon structure according to claim 1, which consists solely of said carbon material, and carbon derived from a binding polymeric material of binding carbon materials together.

3. The carbon structure as recited in claim 1, which has
(a) a pore volume of 1.0 cm³/g to 3.0 cm³/g inclusive taken up by a pore having a diameter of 1 nm to 1,000 nm inclusive as measured by a nitrogen adsorption method,
(b) a pore volume of 1.0 cm³/g to 2.3 cm³ inclusive taken up by a pore having a diameter of 1 nm to 200 nm inclusive as measured by a nitrogen adsorption method,
(c) a pore volume of 1.0 cm³/g to 3.3 cm³/g inclusive taken up by a pore having a diameter of 200 nm to 10,000 nm inclusive as measured by a mercury intrusion method,
(d) a t-plot outer specific surface area of 100 m²/g to 300 m²/g inclusive as measured by a nitrogen adsorption method,
(e) an apparent density of 0.15 g/cm³ to 0.30 g/cm³ inclusive, and
(f) a porosity of 70% to 90% inclusive.

4. The carbon structure as recited in claim 1, which has a self-supporting capability.

5. A positive electrode for an air battery, which comprises the carbon structure as recited in claim 1.

6. An air battery, comprising:
the positive electrode for an air battery as recited in claim 5,
a negative electrode, and
an electrolyte located between said positive electrode for an air battery and said negative electrode.

7. The air battery as recited in claim 6, wherein said negative electrode includes a lithium metal.

8. A process of manufacturing the carbon structure according to claim 2 comprising:
preparing a mixed slurry containing said carbon material and said binding polymeric material,
molding said mixed slurry to obtain a mixed slurry molded assembly,
immersing said mixed slurry molded assembly in a solvent having a lower solubility for said binder polymeric material to obtain a porous structure,
drying said porous structure to obtain a carbon structure precursor, and
carbonizing said carbon structure precursor in an inert atmosphere to obtain a carbon structure.

9. The process of manufacturing the carbon structure as recited in claim 8, wherein said carbonization is carried out in a temperature range of 500° C. to 3,000° C. inclusive.

10. The process of manufacturing the carbon structure as recited in claim 8, wherein subsequent to the provision of said carbon structure precursor by drying of said porous structure and prior to said carbonization, said carbon structure precursor is further made infusible to obtain an infusible carbon structure, wherein:
said infusible carbon structure is subjected to said carbonization.

11. The carbon structure according to claim 1, wherein the carbon nanotube has the average diameter of 1.2 nm to 3 nm inclusive.

12. The carbon structure according to claim 1, wherein the carbon nanotube has the average length of 1 μm to 20 μm inclusive.

13. The carbon structure according to claim 1, wherein the carbon nanotube has the aspect ratio of 3,000 to 6,000 inclusive.

14. The carbon structure according to claim 3, wherein the pore volume taken up by the pore having the diameter of 1 nm to 1,000 nm inclusive as measured by the nitrogen adsorption method in the (a) is 1.2 cm³/g to 2.9 cm³/g inclusive.

15. The carbon structure according to claim 3, wherein the pore volume taken up by the pore having the diameter of 1 nm to 200 nm inclusive as measured by the nitrogen adsorption method in the (b) is 1.1 cm³/g to 2.2 cm³/g inclusive.

16. The carbon structure according to claim 3, wherein the pore volume taken up by the pore having the diameter of 200 nm to 10,000 nm inclusive as measured by the mercury intrusion method in the (c) is 1.0 cm³/g to 3.0 cm³/g inclusive.

17. The carbon structure according to claim 3, wherein the t-plot outer specific surface area as measured by the nitrogen adsorption method in the (d) is 160 m²/g to 250 m²/g inclusive.

18. The carbon structure according to claim 3, wherein the apparent density in the (e) is 0.16 g/cm³ to 0.28 g/cm³ inclusive.

19. The carbon structure according to claim 18, wherein the apparent density in the (e) is 0.20 g/cm³ to 0.28 g/cm³ inclusive.

20. The carbon structure according to claim 3, wherein the porosity in the (f) is 70% to 89% inclusive.
